(19) United States
(12) Patent Application Publication
(10) Pub. No.: US 2021/0324814 A1
(43) Pub. Date: Oct. 21, 2021

(54) Control Device and Diagnostic Method for Internal Combustion Engine

(71) Applicant: Hitachi Automotive Systems, Ltd., Hitachinaka-shi, Ibaraki (JP)

(72) Inventors: Yuichi TOYAMA, Hitachinaka-shi (JP); Atsushi MURAI, Hitachinaka-shi (JP)

(21) Appl. No.: 16/491,414

(22) PCT Filed: Mar. 12, 2019
(86) PCT No.: PCT/JP2019/010000

§ 371 Date: Sep. 5, 2019

(30) Foreign Application Priority Data
Jul. 11, 2018 (JP) 2018-131349

(51) Int. Cl. F02D 41/22; F02D 41/38

(52) U.S. Cl. CPC F02D 41/22; F02D 2041/224; F02D 41/38

(57) ABSTRACT

A control device and a diagnostic method according to the present invention is applicable to an internal combustion engine provided with a first fuel injection valve and a second fuel injection valve for a cylinder. When there is an abnormality that makes an air-fuel ratio of the internal combustion engine richer than a specified value, it is determined whether the first fuel injection valve or the second fuel injection valve has the abnormality, based on change of the air-fuel ratio occurring as a result of first injection control for performing fuel injection while changing a distribution ratio of a fuel injection amount distributed to the first fuel injection valve to a fuel injection amount distributed to the second fuel injection valve, and a value of the air-fuel ratio obtained as a result of second injection control for performing fuel injection while maintaining the distribution ratio at a predetermined ratio.

### TECHNICAL FIELD

The present invention relates to a control device and a diagnostic method for an internal combustion engine, and specifically relates to a technique for diagnosing whether or not an abnormality has occurred in a first fuel injection valve and a second fuel injection valve provided for each cylinder in an internal combustion engine.

### BACKGROUND ART

Patent Document 1 discloses an abnormality diagnostic device for an engine system provided with two fuel injection valves for each cylinder. When an air-fuel ratio abnormality has occurred in a cylinder, the abnormality diagnostic device carries out, on the cylinder, injection ratio changing control for gradually changing the ratio between the commanded injection amounts of the two fuel injection valves while keeping the sum of the commanded injection amounts of the two fuel injection valves constant, and uses an air-fuel ratio feedback correction variable learned during the injection ratio changing control to determine which of the two fuel injection valves of the cylinder has an abnormality.

### REFERENCE DOCUMENT LIST

### Patent Document

Patent Document 1: JP 2009-180171 A

### SUMMARY OF THE INVENTION

### Problem to be Solved by the Invention

Assume here the case in which a measurement abnormality, which is a deviation of a fuel injection amount from the designed amount for the injection pulse width, has occurred in, for example, a first fuel injection valve of the two fuel injection valves. In this case, when the deviation of the fuel injection amount is upward relative to the designed amount, the air-fuel ratio is abnormally richer than the specified value.

At that time, if the abnormality diagnostic device carries out the injection ratio changing control for gradually increasing the injection ratio of the first fuel injection valve to the second fuel injection valve, the air-fuel ratio will be still richer.

Here, the air-fuel ratio may also be abnormally richer than the specified value when valve sticking open occurs, e.g., when the valve member of a second fuel injection valve of the two fuel injection valves is abnormally stuck at an open valve position and thus, the second fuel injection valve continuously injects fuel, due to, for example, foreign matter or the like entering the valve.

At that time, if the abnormality diagnostic device carries out the injection ratio changing control for increasing the injection ratio of the first fuel injection valve to the second fuel injection valve, the rich-shift abnormality increases.

That is, both when the first fuel injection valve has a measurement abnormality and when the second fuel injection valve is stuck open, the air-fuel ratio is changed in the same direction by the injection ratio changing control.

Therefore, the diagnosis based on the direction in which the air-fuel ratio is changed by the injection ratio changing control may erroneously determine that an abnormality has occurred in a fuel injection valve that is actually in a normal condition.

The present invention has been made in view of such conventional circumstances, and an object thereof is to improve the accuracy of abnormality diagnosis of the first fuel injection valve and the second fuel injection valve.

### Means for Solving the Problem

A control device for an internal combustion engine according to an aspect of the present invention is applicable to an internal combustion engine provided with a first fuel injection valve and a second fuel injection valve for a cylinder, and comprises a diagnosing unit configured such that, when there is an abnormality that makes an air-fuel ratio of the internal combustion engine richer than a specified value, the diagnosing unit determines whether the first fuel injection valve or the second fuel injection valve has the abnormality, based on change of the air-fuel ratio occurring as a result of first injection control for performing fuel injection while changing a distribution ratio of a fuel injection amount distributed to the first fuel injection valve to a fuel injection amount distributed to the second fuel injection valve, and a value of the air-fuel ratio obtained as a result of second injection control for performing fuel injection while maintaining the distribution ratio at a predetermined ratio.

A diagnostic method according to an aspect of the present invention is applicable to an internal combustion engine provided with a first fuel injection valve and a second fuel injection valve for a cylinder, and comprises carrying out first injection control for performing fuel injection while changing a distribution ratio of a fuel injection amount distributed to the first fuel injection valve to a fuel injection amount distributed to the second fuel injection valve, when there is an abnormality that makes an air-fuel ratio of the internal combustion engine richer than a specified value; determining change of the air-fuel ratio occurring as a result of the first injection control; carrying out second injection control for performing fuel injection while maintaining the distribution ratio at a predetermined ratio; determining a deviation, from the specified value, of the air-fuel ratio obtained as a result of the second injection control; and determining whether the first fuel injection valve or the second fuel injection valve has the abnormality, based on the change of the air-fuel ratio occurring as a result of the first injection control and the deviation of the air-fuel ratio obtained as a result of the second injection control.

### Effects of the Invention

According to the invention described above, it is possible to improve the accuracy of abnormality diagnosis of the first fuel injection valve and the second fuel injection valve.

### BRIEF DESCRIPTION OF THE DRAWINGS

FIG. 1 shows a system configuration of an internal combustion engine.

FIG. 2 shows an arrangement of fuel injection valves in the internal combustion engine.

FIG. 3 is a flowchart showing a first embodiment of abnormality diagnosis of fuel injection valves.

FIG. 4 is a flowchart showing the first embodiment of abnormality diagnosis of the fuel injection valves.

FIG. 5 is a table for illustrating the correlation between the valve injection distribution ratio and the valve injection amounts when a first fuel injection valve has a measurement abnormality.

FIG. 6 is a table for illustrating the correlation between the valve injection distribution ratio and the valve injection amounts when a second fuel injection valve has a measurement abnormality.

FIG. 7 is a table for illustrating the correlation between the valve injection distribution ratio and the valve injection amounts when the second fuel injection valve is stuck open.

FIG. 8 is a table for illustrating the correlation between the valve injection distribution ratio and the valve injection amounts when the first fuel injection valve is stuck open.

FIG. 9 is a table showing injection amounts when the first fuel injection valve has a measurement abnormality and fuel is injected solely by the second fuel injection valve.

FIG. 10 is a table showing injection amounts when the second fuel injection valve is stuck open and fuel is injected solely by the second fuel injection valve.

FIG. 11 is a table showing injection amounts when the second fuel injection valve has a measurement abnormality and fuel is injected solely by the first fuel injection valve.

FIG. 12 is a table showing injection amounts when the first fuel injection valve is stuck open and fuel is injected solely by the first fuel injection valve.

FIG. 13 is a flowchart showing a second embodiment of abnormality diagnosis of the fuel injection valves.

FIG. 14 is a flowchart showing the second embodiment of abnormality diagnosis of the fuel injection valves.

FIG. 15 is a flowchart showing a third embodiment of abnormality diagnosis of the fuel injection valves.

FIG. 16 is a flowchart showing the third embodiment of abnormality diagnosis of the fuel injection valves.

### MODES FOR CARRYING OUT THE INVENTION

An embodiment of the present invention will be described below.

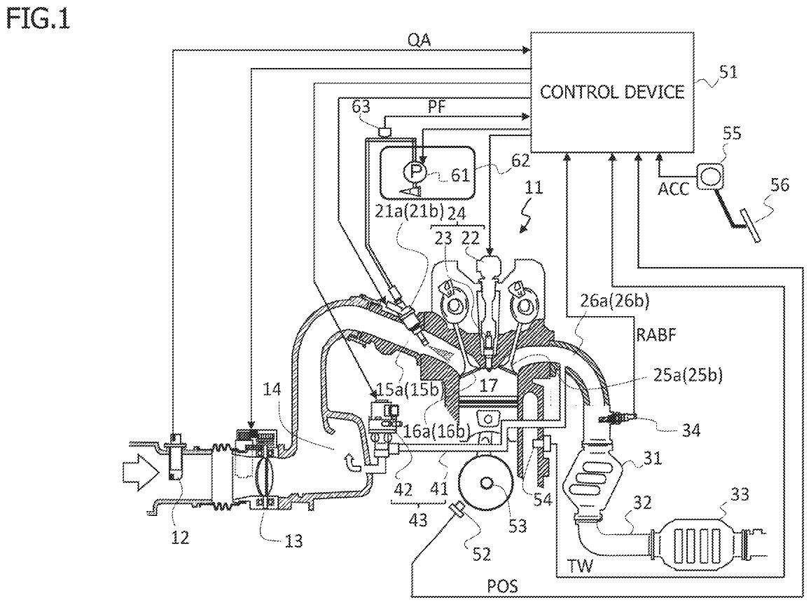

FIG. 1 is a system configuration diagram showing an aspect of an internal combustion engine 11 for a vehicle to which a control device and a diagnostic method according to the present invention are applied.

In FIG. 1, the intake air entering internal combustion engine 11 passes through an air flow meter 12, an electronically controlled throttle valve 13, and an collector 14 in this order, and then enters combustion chambers 17 through intake ports 15a, 15b and intake valves 16a, 16b (two intake ports 15a, 15b and two intake valves 16a, 16b are provided for each cylinder).

Among intake ports 15a, 15b, a first intake port 15a is provided with a first fuel injection valve 21a, and a second intake port 15b is provided with a second fuel injection valve 21b. Fuel injection valves 21a, 21b inject fuel into intake ports 15a, 15b.

That is, internal combustion engine 11 is provided with first fuel injection valve 21a and second fuel injection valve 21b for each cylinder.

An electric fuel pump 61 pressurizes fuel in a fuel tank 62 to a predetermined pressure and supplies the pressurized fuel to these two fuel injection valves 21a, 21b.

Each fuel injection valve 21a, 21b injects fuel in an amount proportional to its valve opening time (injection pulse width).

A fuel pressure sensor 63 detects a fuel pressure PF, which is the pressure of fuel supplied to two fuel injection valves 21a, 21b.

Internal combustion engine 11 further includes an ignition device 24 for each cylinder, and each ignition device 24 has an ignition coil 22 and a spark plug 23.

In each combustion chamber 17, air-fuel mixture is ignited by a spark of spark plug 23 and combustion takes place. The exhaust gas produced by the combustion in combustion chamber 17 flows out to an exhaust system through two exhaust valves 25a, 25b and two exhaust ports 26a, 26b provided for each cylinder.

The exhaust system of internal combustion engine 11 includes a first catalytic device 31 and a second catalytic device 33. First catalytic device 31 is disposed immediately below the junction of exhaust ports 26a, 26b. Second catalytic device 33 is disposed in an exhaust duct 32 downstream of first catalytic device 31.

Each of first catalytic device 31 and second catalytic device 33 includes a three-way catalyst.

Internal combustion engine 11 further includes an air-fuel ratio sensor 34 configured to detect an air-fuel ratio and provided upstream of first catalytic device 31. Air-fuel ratio sensor 34 detects an exhaust air-fuel ratio RABF at a point upstream of first catalytic device 31.

Internal combustion engine 11 further includes an exhaust gas recirculation device 43 having an exhaust gas recirculation pipe 41 and an exhaust gas recirculation control valve 42. Exhaust gas recirculation pipe 41 connects an exhaust pipe 26 with collector 14 in communication. Exhaust gas recirculation control valve 42 is configured to adjust the opening area of exhaust gas recirculation pipe 41; in other words, configured to adjust the exhaust gas recirculation rate.

Control device 51 is an electronic controller that includes a microcomputer having a processor and a memory. In accordance with a control program, control device 51 performs arithmetic processing on detection signals output by various sensors so as to control fuel injection from fuel injection valves 21a, 21b, the opening degree of electronically controlled throttle valve 13, ignition by spark plugs 23, the opening degree of exhaust gas recirculation control valve 42, the fuel discharge rate of fuel pump 61, and the like.

Control device 51 receives an output signal of fuel pressure sensor 63 that is dependent on the fuel pressure PF and an output signal of air-fuel ratio sensor 34 that is dependent on the exhaust air-fuel ratio RABF. In addition, control device 51 also receives signals such as an output signal of air flow meter 12 that is dependent on an intake air flow rate QA of internal combustion engine 11, an output signal of a crank angle sensor 52 that is dependent on a rotational angle position POS of a crankshaft 53, an output signal of a water temperature sensor 54 that is dependent on a coolant temperature TW of internal combustion engine 11, and an output signal of an accelerator position sensor 55 that is dependent on a depression amount ACC of an accelerator pedal 56.

Control device 51 calculates an engine rotation speed NE based on the rotational angle position POS of crankshaft 53, and determines an engine load based on the intake air flow rate QA and the engine rotation speed NE.

Then, control device 51 calculates a target ignition timing and a target exhaust gas recirculation rate in accordance with engine operating conditions such as the engine load, the engine rotation speed NE, and the coolant temperature TW.

Control device 51 outputs ignition signals to ignition coils 22 in accordance with their respective target ignition timings, and outputs an opening degree control signal to exhaust gas recirculation control valve 42 in accordance with the target exhaust gas recirculation rate.

Furthermore, control device 51 calculates a target opening degree of electronically controlled throttle valve 13 based on the accelerator position ACC and the like, and controls the drive of the throttle motor of electronically controlled throttle valve 13 in accordance with the target opening degree.

Control device 51 also controls the voltage applied to the motor of fuel pump 61 so that the fuel pressure FP detected by fuel pressure sensor 63 approaches a target fuel pressure so as to adjust the fuel discharge rate of fuel pump 61.

Furthermore, control device 51 calculates a fuel injection pulse width TI (ms), which corresponds to the total amount of fuel injected by fuel injection valves 21a, 21b per combustion cycle. In accordance with a ratio of distribution between fuel injection valves 21a, 21b, control device 51 then distributes the fuel injection pulse width TI between fuel injection valves 21a, 21b, and causes fuel injection valves 21a, 21b to inject corresponding amounts of fuel. In this way, control device 51 controls the air-fuel ratio of internal combustion engine 11.

Based on the intake air flow rate QA and the engine rotation speed NE, control device 51 calculates a basic fuel injection pulse width TP for producing a target air-fuel ratio, i.e., a specified air-fuel ratio. In addition, control device 51 also specifies an air-fuel ratio feedback correction value LAMBDA for correcting the basic fuel injection pulse width TP so that the air-fuel ratio value detected by air-fuel ratio sensor 34 approaches the target air-fuel ratio.

Then, control device 51 determines the fuel injection pulse width TI based on the basic fuel injection pulse width TP, the air-fuel ratio feedback correction value LAMBDA, and the like.

As used herein, the term “base air-fuel ratio” refers to an actual air-fuel ratio produced when fuel is injected using the fuel injection pulse width TI that is not subjected to correction control carried out based on the air-fuel ratio value detected by the air-fuel ratio sensor 34; that is, refers to an actual air-fuel ratio that is not subjected to correction for making the air-fuel ratio equal to the target air-fuel ratio. Also, as used herein, the term “air-fuel ratio error” refers to a deviation of the base air-fuel ratio from the target air-fuel ratio, and corresponds to a correction amount of the fuel injection pulse width TI used in correction based on the air-fuel ratio value detected by the air-fuel ratio sensor 34.

For example, when the injection amount is greater than the desired amount for the injection pulse width, so that the actual air-fuel ratio is richer than the target air-fuel ratio, the injection pulse width is corrected downward by the air-fuel ratio correction control so as to adjust the actual air-fuel ratio to the target air-fuel ratio. In this case, the base air-fuel ratio corresponds to an actual air-fuel ratio that is not subjected to correction for making the injection pulse width shorter, that is, richer than the target air-fuel ratio.

In other words, the air-fuel ratio correction amount used in the air-fuel ratio correction that eliminates the deviation of the actual air-fuel ratio from the target air-fuel ratio and thus, makes the actual air-fuel ratio equal to the target air-fuel ratio, corresponds to the deviation of the base air-fuel ratio, which is the actual air-fuel ratio that is not subjected to the air-fuel ratio correction, from the target air-fuel ratio; that is, corresponds to the air-fuel ratio error.

As described above, control device 51 carries out control to distribute, between first fuel injection valve 21a and second fuel injection valve 21b, the fuel injection pulse width TI, which is proportional to the total fuel injection amount.

The basic value of the distribution ratio is 5:5. When the distribution ratio is set to 5:5, control device 51 causes first fuel injection valve 21a to inject fuel in an amount corresponding to half (50%) of the fuel injection pulse width TI and causes second fuel injection valve 21b to inject fuel in an amount corresponding to half (50%) of the fuel injection pulse width TI.

Control device 51 can change the distribution ratio to any value. Specifically, control device 51 may change the distribution ratio stepwise from 5:5 to 0:10 or 10:0.

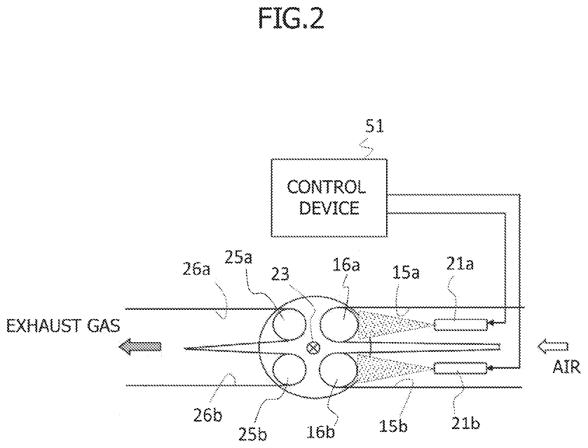

FIG. 2 shows an arrangement of fuel injection valves 21a, 21b in intake ports 15a, 15b.

Internal combustion engine 11 is a four-valve four-stroke engine provided with two intake valves 16a, 16b and two exhaust valves 25a, 25b for each cylinder.

First intake valve 16a opens and closes first intake port 15a. Second intake valve 16b opens and closes second intake port 15b.

First fuel injection valve 21a is disposed in first intake port 15a at a point upstream of first intake valve 16a, and injects fuel to the valve head of first intake valve 16a.

Second fuel injection valve 21b is disposed in second intake port 15b at a point upstream of second intake valve 16b, and injects fuel to the valve head of second intake valve 16b.

However, fuel injection valves 21a, 21b may be disposed in an arrangement different from that in FIG. 2.

For example, fuel injection valves 21a, 21b may be disposed upstream and downstream of the same intake port, respectively.

Also, fuel injection valves 21a, 21b need not necessarily be one-way injection valves configured to inject fuel in one direction. At least one of fuel injection valves 21a, 21b may be two-way injection valves configured to inject fuel in two directions.

Control device 51 has a software-based function to control fuel injection from fuel injection valves 21a, 21b and a software-based diagnostic function to diagnose whether an abnormality has occurred in fuel injection valves 21a, 21b; that is, a software-based function to serve as a diagnosing unit.

### First Embodiment

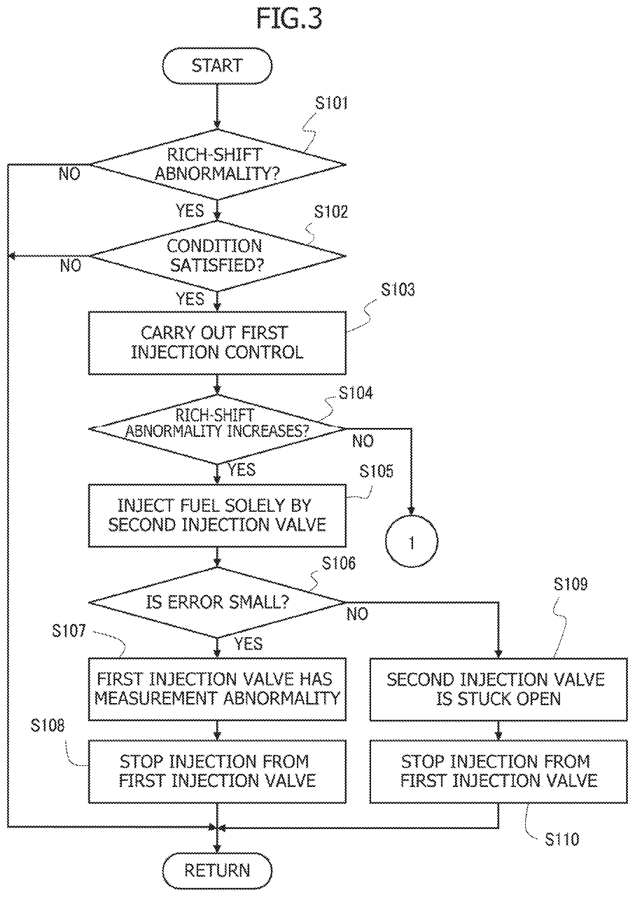

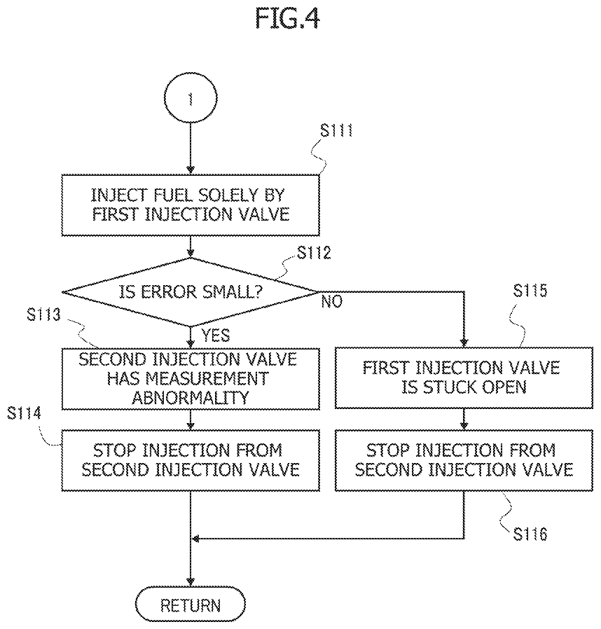

The flowcharts of FIGS. 3 and 4 show the procedure of diagnostic processing performed on fuel injection valves 21a, 21b by control device 51.

First, in step S101, based on the air-fuel ratio correction value used in an air-fuel ratio feedback control, control device 51 determines whether or not a rich-shift abnormality has occurred in internal combustion engine 11. As used herein, the term “rich-shift abnormality” refers to an abnormality that makes the base air-fuel ratio richer than the target air-fuel ratio by a value greater than a predetermined value; in other words, an abnormality that makes the air-fuel ratio of internal combustion engine 11 richer than a specified value.

That is, when the air-fuel ratio correction value used in the air-fuel ratio feedback control exceeds a threshold for determining the occurrence of a rich-shift abnormality, so that the injection pulse width is corrected downward by an amount greater than when the air-fuel ratio correction value is equal to the threshold, control device 51 determines that a rich-shift abnormality has occurred.

Then, when control device 51 determines that a rich-shift abnormality has occurred, the operation proceeds to step S102. In step S102, control device 51 determines whether or not a diagnosis permission condition is satisfied to permit processing for diagnosing which of fuel injection valves 21a, 21b has an abnormality that causes the rich-shift abnormality.

For example, control device 51 may determine in step S102 that the diagnosis permission condition is satisfied, when internal combustion engine 11 is idling or operating in a steady state within a load range that is low enough to allow fuel injection solely from one of fuel injection valves 21a, 21b to provide an air-fuel mixture having the target air-fuel ratio.

Alternatively or additionally, control device 51 may use, as the diagnosis permission condition, whether it is the start of the air-fuel ratio feedback control.

When the diagnosis permission condition is satisfied, the operation proceeds to step S103, in which control device 51 carries out first injection control for performing fuel injection while stepwise changing ratio for distributing the total fuel injection amount between first fuel injection valve 21a and second fuel injection valve 21b, and determines change in the air-fuel ratio error occurring as a result of the first injection control.

That is, in the first injection control, fuel injection is performed while changing the ratio of the fuel injection amount distributed to first fuel injection valve 21a to the fuel injection amount distributed to second fuel injection valve 21b, and control device 51 determines the change of the air-fuel ratio occurring as a result of the first injection control.

Control device 51 determines the change of the air-fuel ratio error based on the change of the air-fuel ratio correction value used in the air-fuel ratio feedback control.

When internal combustion engine 11 is provided with an air-fuel ratio detector for detecting the air-fuel ratio for each cylinder so that control device 51 can determine whether and which of the cylinders has a rich-shift abnormality, control device 51 may determine change of the air-fuel ratio error during fuel injection while changing the valve injection distribution ratio only for the cylinder that has the rich-shift abnormality.

On the other hand, when control device 51 cannot determine the individual air-fuel ratios of the cylinders and can merely determine the average air-fuel ratio of all the cylinders, control device 51 determines change of the air-fuel ratio error during fuel injection while changing the valve injection distribution ratio for each cylinder by sequentially switching a target cylinder among the cylinders.

In the first injection control of step S103, control device 51 stepwise increases the distribution ratio of first fuel injection valve 21a to second fuel injection valve 21b (i.e., stepwise increases the distribution ratio of first fuel injection valve 21a so as to relatively decrease the distribution ratio of second fuel injection valve 21b) from a predetermined distribution ratio such as 5:5.

Alternatively, control device 51 may stepwise increase the distribution ratio of second fuel injection valve 21b to first fuel injection valve 21a (i.e., may stepwise increase the distribution ratio of second fuel injection valve 21b so as to relatively decrease the distribution ratio of first fuel injection valve 21a) from the predetermined distribution ratio.

However, processing for stepwise increasing the distribution ratio of second fuel injection valve 21b to first fuel injection valve 21a is substantially the same as processing for stepwise increasing the distribution ratio of first fuel injection valve 21a to second fuel injection valve 21b.

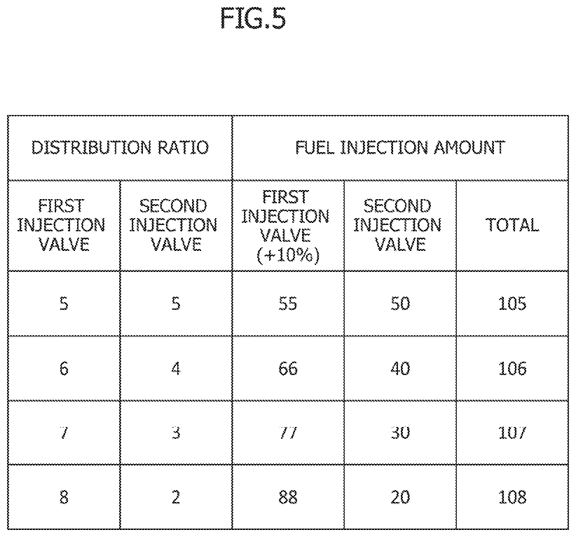

In an aspect of the distribution ratio change shown in FIG. 5, control device 51 stepwise changes the distribution ratio from 5:5 to 6:4, then to 7:3, and then to 8:2.

Hereinafter, the correlation between the change in the air-fuel ratio error along with the change in the distribution ratio and the abnormality in the fuel injection valves will be described with reference to FIGS. 5 to 8.

The fuel injection amounts at each distribution ratio in FIGS. 5 to 8 are relative amounts of fuel injected by fuel injection valves 21a, 21b, with 100 representing the total fuel injection amount.

For example, assume here that a rich-shift abnormality has caused by a measurement abnormality in first fuel injection valve 21a that makes the fuel injection amount greater than the designed amount for the injection pulse width by 10%.

In this case, as shown in FIG. 5, as the distribution ratio of first fuel injection valve 21a increases, an excessive fuel injection amount of first fuel injection valve 21a increases. Thus, as the distribution ratio changes stepwise from 5:5 to 6:4, then to 7:3, and then to 8:2, the total fuel injection amount increases stepwise so that the air-fuel ratio becomes still richer and the air-fuel ratio error increases.

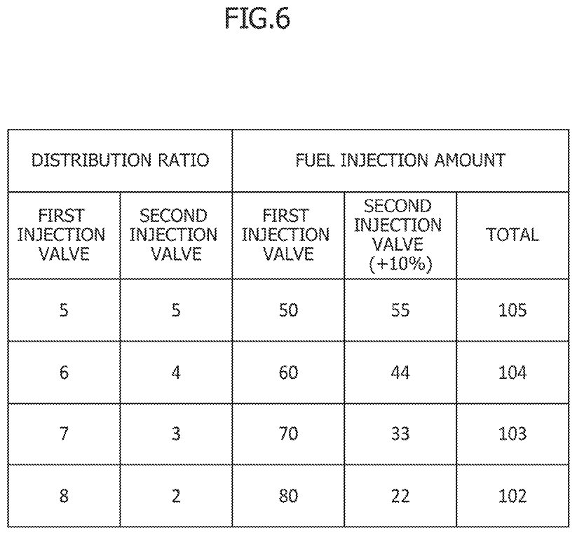

On the other hand, assume here that a rich-shift abnormality has caused by a measurement abnormality in second fuel injection valve 21b that makes the fuel injection amount greater than the designed amount for the injection pulse width by 10%. In this case, as shown in FIG. 6, as the distribution ratio of second fuel injection valve 21b decreases, an excessive fuel injection amount of second fuel injection valve 21b decreases.

Thus, as the distribution ratio changes stepwise from 5:5 to 6:4, then to 7:3, and then to 8:2, the total fuel injection amount decreases stepwise so that the air-fuel ratio changes to the leaner side to approach the target air-fuel ratio and the air-fuel ratio error decreases.

Therefore, when the cause of the rich-shift abnormality is a measurement abnormality of first fuel injection valve 21a or second fuel injection valve 21b, control device 51 can determine whether first fuel injection valve 21a or second fuel injection valve 21b has the measurement abnormality, based on the direction in which the air-fuel ratio changes as the distribution ratio changes stepwise.

However, a rich-shift abnormality may also be caused when valve sticking open occurs, i.e., when first fuel injection valve 21a or second fuel injection valve 21b is stuck open and continuously injects fuel due to, for example, foreign matter or the like entering the valve. When the cause of the rich-shift abnormality is such valve sticking open, the diagnostic processing based on the direction in which the air-fuel ratio is changed by the first injection control may let control device 51 erroneously diagnose that an abnormality has occurred in a fuel injection valve that is actually in a normal condition.

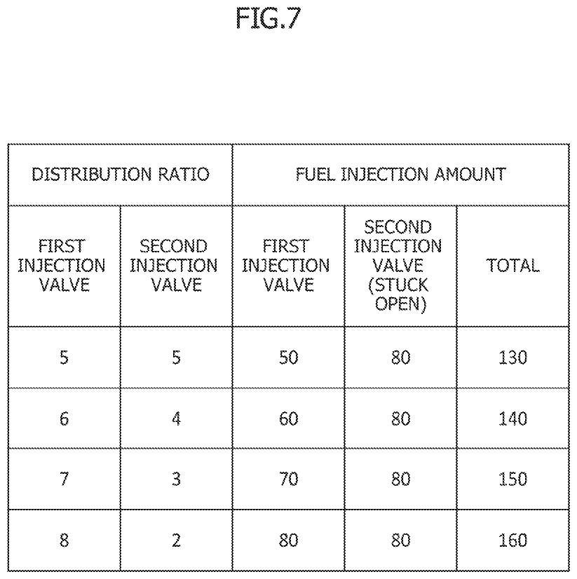

FIG. 7 shows how the rich-shift abnormality changes as the distribution ratio changes stepwise when second fuel injection valve 21b is stuck open and first fuel injection valve 21a is in a normal condition.

In FIG. 7, it is assumed that the amount of fuel injected by the fuel injection valve that is stuck open is 80% of the command value of the total fuel injection amount per combustion cycle.

In this case, no matter how the distribution ratio of second fuel injection valve 21b changes, second fuel injection valve 21b continues to inject a fixed amount of fuel.

Thus, as the distribution ratio of first fuel injection valve 21a increases stepwise and the amount of fuel injected by first fuel injection valve 21a increases, the total fuel injection amount, which is the sum of the amount of fuel injected by first fuel injection valve 21a and the amount of fuel injected by second fuel injection valve 21b, also increases stepwise and the rich-shift abnormality increases.

Accordingly, both when first fuel injection valve 21a has a measurement abnormality (see FIG. 5) and when second fuel injection valve 21b is stuck open (see FIG. 7), the rich-shift abnormality increases i.e., changes in the same direction, as the distribution ratio changes. Therefore, control device 51 cannot distinguish between the measurement abnormality of first fuel injection valve 21a and the sticking open of second fuel injection valve 21b.

In other words, abnormality diagnosis based on the fact that the base air-fuel ratio becomes richer as control device 51 stepwise increases the distribution ratio of first fuel injection valve 21a to second fuel injection valve 21b may let control device 51 erroneously determine that a measurement abnormality has occurred in first fuel injection valve 21a when, in fact, second fuel injection valve 21b is stuck open.

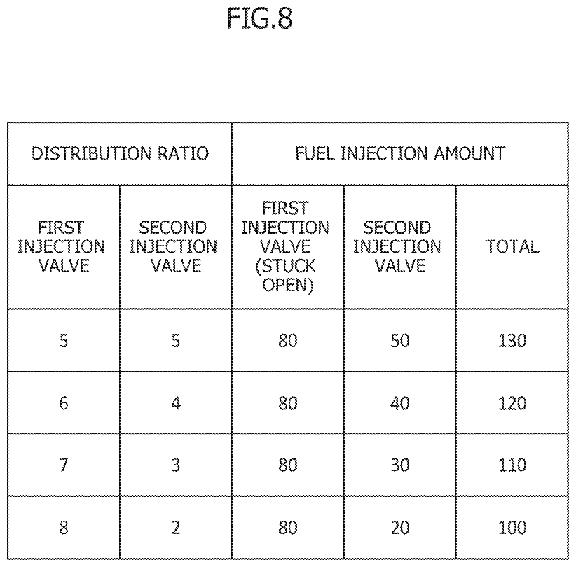

FIG. 8 shows how the rich-shift abnormality changes as the distribution ratio changes stepwise when first fuel injection valve 21a is stuck open and second fuel injection valve 21b is in a normal condition.

In this case, no matter how the distribution ratio of first fuel injection valve 21a changes, first fuel injection valve 21a continues to inject a fixed amount of fuel. Thus, as the distribution ratio of second fuel injection valve 21b decreases stepwise and the amount of fuel injected by second fuel injection valve 21b decreases, the total fuel injection amount, which is the sum of the amount of fuel injected by first fuel injection valve 21a and the amount of fuel injected by second fuel injection valve 21b, also decreases stepwise and the rich-shift abnormality decreases.

Accordingly, both when second fuel injection valve 21b has a measurement abnormality (see FIG. 6) and when first fuel injection valve 21a is stuck open, the rich-shift abnormality decreases i.e., changes in the same direction, as the distribution ratio changes. Therefore, control device 51 cannot distinguish between the sticking open of first fuel injection valve 21a and the measurement abnormality of second fuel injection valve 21b.

To address the above, control device 51 carries out second injection control in step S104 and subsequent steps in order to distinguish between the measurement abnormality and the valve sticking open.

First, in step S104, control device 51 determines whether or not the rich-shift abnormality increases as control device 51 stepwise increases the distribution ratio of first fuel injection valve 21a to second fuel injection valve 21b.

As described above, the cause of the increase in the rich-shift abnormality along with the stepwise change in the distribution ratio may be either a measurement abnormality of first fuel injection valve 21a or sticking open of second fuel injection valve 21b. It is thus necessary to distinguish which of them is the actual cause.

When the determination result is “Yes” in step S104, the operation proceeds to step S105, in which control device 51 causes second fuel injection valve 21b, which may be stuck open, to inject all the commanded total fuel injection amount, and stops the fuel injection from first fuel injection valve 21a; that is, sets the distribution ratio to 0:10.

Under normal conditions, control device 51 sets the distribution ratio of the injection amount of first fuel injection valve 21a to the injection amount of second fuel injection valve 21b at 5:5, and causes each of fuel injection valves 21a, 21b to inject fuel in half the amount appropriate for the intake air amount in a high load range at most. Accordingly, the maximum amount of fuel that can be injected by a single fuel injection valve is set to an amount less than the amount of fuel that is appropriate for an intake air amount in a load range higher than a predetermined level.

Thus, control device 51 may set the distribution ratio to 0:10 in step S105 only under load conditions in which the air-fuel mixture having the target air-fuel ratio can be generated with an amount of fuel that can be injected by a single fuel injection valve.

Therefore, control device 51 may use, as the diagnosis permission condition in step S102, whether internal combustion engine 11 is in a load range that is low enough to allow fuel injection solely from a single fuel injection valve to provide an air-fuel mixture having the target air-fuel ratio. Alternatively, before setting the distribution ratio to 0:10 in step S105, control device 51 may limit the amount of intake air to the maximum amount of air that allows fuel injection solely from a single fuel injection valve to provide the air-fuel mixture having the target air-fuel ratio.

In step S111, which will be described later, as well, control device 51 causes one of fuel injection valves 21a, 21b to inject fuel while suppressing the increase in the amount of intake air compared to under normal conditions.

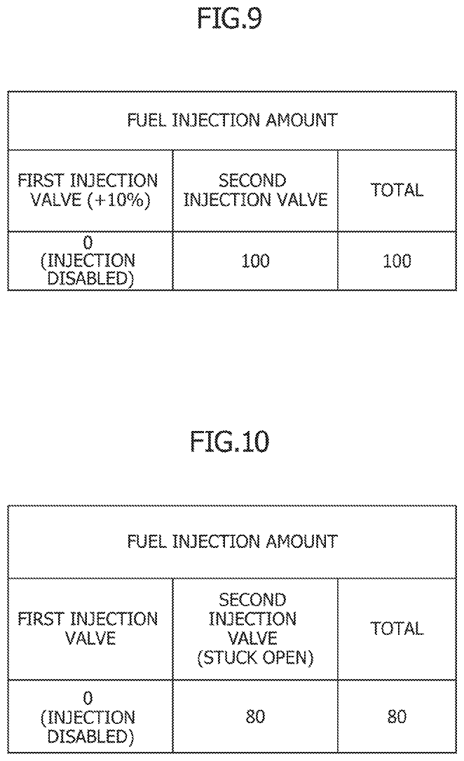

Assume the case in which the cause of the rich-shift abnormality is a measurement abnormality of first fuel injection valve 21a and fuel is injected solely by second fuel injection valve 21b. This means that the fuel injection valve in a normal condition solely injects fuel. Thus, second fuel injection valve 21b injects fuel in a commanded amount, as shown in FIG. 9.

As a result, the rich-shift abnormality of the base air-fuel ratio due to the measurement abnormality of first fuel injection valve 21a is substantially eliminated, and the air-fuel ratio correction value used in the air-fuel ratio feedback control approaches an initial value, containing no variable for correcting the injection pulse width.

Assume the case in which the cause of the rich-shift abnormality is sticking open of second fuel injection valve 21b and fuel is injected solely by second fuel injection valve 21b. In this case, as shown in FIG. 10, no matter how the injection pulse width of second fuel injection valve 21b is corrected by the air-fuel ratio feedback control, the fuel injection amount of second fuel injection valve 21b remains unchanged and thus, the air-fuel ratio does not approach the target air-fuel ratio. Accordingly, the air-fuel ratio correction variable is added by each round of air-fuel ratio feedback control, and the resultant air-fuel ratio correction value departs from the initial value.

Therefore, when control device 51 determines in step S106 that, as a result of the air-fuel ratio feedback control carried out by causing second fuel injection valve 21b solely to inject fuel, the air-fuel ratio correction value used therein is near the initial value, and thus that the resultant air-fuel ratio error is smaller than the predetermined value and the resultant base air-fuel ratio is close to the target air-fuel ratio, the operation proceeds to step S107. In step S107, control device 51 determines that first fuel injection valve 21a has a measurement abnormality and second fuel injection valve 21b is in a normal condition.

On the other hand, when control device 51 determines in step S106 that, as a result of the air-fuel ratio feedback control carried out by causing second fuel injection valve 21b solely to inject fuel, the air-fuel ratio correction value used therein departs from the initial value by a predetermined amount or more, and thus that the resultant air-fuel ratio error is greater than the predetermined value and the resultant base air-fuel ratio deviates from the target air-fuel ratio by a predetermined amount or more, the operation proceeds to step S109. In step S109, control device 51 determines that second fuel injection valve 21b is stuck open, i.e., has a continuous injection abnormality and first fuel injection valve 21a is in a normal condition.

As described above, when the rich-shift abnormality increases as a result of the first injection control for performing fuel injection while stepwise changing the distribution ratio, control device 51 stops the fuel injection from first fuel injection valve 21a and carries out the second injection control for causing second fuel injection valve 21b solely to inject fuel.

Then, based on the magnitude of the air-fuel ratio error when fuel is injected solely by second fuel injection valve 21b, control device 51 determines whether first fuel injection valve 21a or second fuel injection valve 21b has an abnormality and, in addition, whether the abnormality is a measurement abnormality or valve sticking open.

This prevents or reduces control device 51 from erroneously determining sticking open of second fuel injection valve 21b as a measurement abnormality of first fuel injection valve 21a.

After control device 51 determines whether first fuel injection valve 21a or second fuel injection valve 21b has an abnormality in step S107 or S109, control device 51 performs fail-safe processing, which corresponds to abnormality-addressing processing, based on the determination result.

That is, control device 51 has a software-based function to serve as an abnormality-addressing processing unit configured to perform abnormality-addressing processing in accordance with a diagnosis provided by the diagnosing unit.

When control device 51 determines in step S107 that first fuel injection valve 21a has a measurement abnormality and second fuel injection valve 21b is in a normal condition, the operation proceeds to step S108. In step S108, control device 51 stops the fuel injection from first fuel injection valve 21a, which has the measurement abnormality, and causes second fuel injection valve 21b, which is in a normal condition, solely to inject fuel so as to operate internal combustion engine 11.

This allows continuous operation of internal combustion engine 11 with a sufficiently minimized deviation of the base air-fuel ratio.

On the other hand, when control device 51 determines in step S109 that first fuel injection valve 21a is in a normal condition and second fuel injection valve 21b is stuck open, the operation proceeds to step S110. In step S110, control device 51 stops the fuel injection from first fuel injection valve 21a, which is in a normal condition, and causes second fuel injection valve 21b, which is stuck open, solely to inject fuel so as to operate internal combustion engine 11.

In this case, control device 51 cannot stop the fuel injection or adjust the injection amount of second fuel injection valve 21b, and thus, lets second fuel injection valve 21b continuously inject fuel. On the other hand, control device 51 can stop the fuel injection from first fuel injection valve 21a, which is in a normal condition.

Thus, control device 51 stops the fuel injection from first fuel injection valve 21a, to reduce the total fuel injection amount as practicably as possible and to prevent or reduce rich-shift abnormality that may occur while internal combustion engine 11 continues to operate in a low load range.

Here, when control device 51 performs the fail-safe processing of stopping the fuel injection from first fuel injection valve 21a and causing second fuel injection valve 21b solely to inject fuel so as to operate internal combustion engine 11 in step S108 or S110, internal combustion engine 11 needs to operate within a lower load range that is low enough to allow fuel injection solely from second fuel injection valve 21b to provide an air-fuel mixture having the target air-fuel ratio.

Therefore, control device 51 lowers the upper opening limit in the opening control of electronically controlled throttle valve 13 compared to when both first fuel injection valve 21a and second fuel injection valve 21b are in a normal condition.

In addition, as part of the fail-safe processing in step S108 or S110, control device 51 may store, as a diagnosis history in a non-volatile memory, the determination result that first fuel injection valve 21a has a measurement abnormality or that second fuel injection valve 21b is stuck open, and may use a warning device, such as a lamp, to warn the driver of the vehicle that an abnormality has occurred in the fuel system or internal combustion engine 11.

On the other hand, when control device 51 determines in step S104 that the rich-shift abnormality decreases as control device 51 stepwise increases the distribution ratio of first fuel injection valve 21a to second fuel injection valve 21b in step S103, the operation proceeds to step S111.

As described above, the cause of the decrease in the rich-shift abnormality along with the stepwise change in the distribution ratio may be either sticking open of first fuel injection valve 21a or a measurement abnormality of second fuel injection valve 21b. It is thus necessary to distinguish which of them is the actual cause.

When the determination result is “No” in step S104, the operation proceeds to step S111, in which control device 51 causes first fuel injection valve 21a, which may be stuck open, to inject all the commanded total fuel injection amount, and stops the fuel injection from second fuel injection valve 21b; that is, sets the distribution ratio to 10:0.

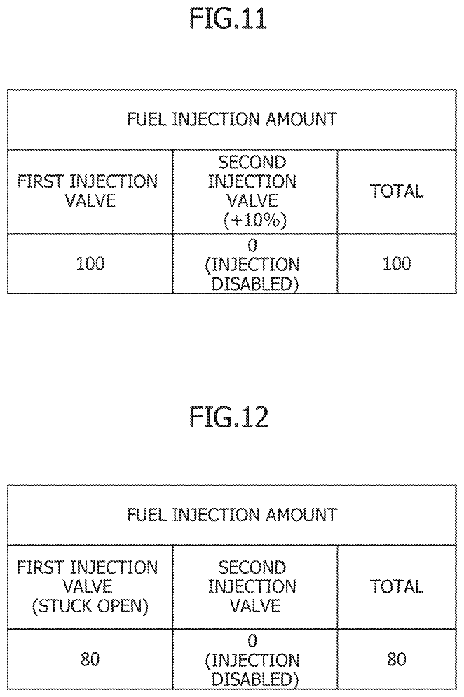

Assume the case in which the cause of the rich-shift abnormality is a measurement abnormality of second fuel injection valve 21b and control device 51 causes first fuel injection valve 21a solely to inject fuel. This means that the fuel injection valve in a normal condition solely injects fuel. Thus, first fuel injection valve 21a injects fuel in a commanded amount, as shown in FIG. 11.

As a result, the rich-shift abnormality of the base air-fuel ratio due to the measurement abnormality of second fuel injection valve 21b is substantially eliminated, and the air-fuel ratio correction value used in the air-fuel ratio feedback control approaches the initial value, containing no variable for correcting the injection pulse width.

Assume the case in which the cause of the rich-shift abnormality is sticking open of first fuel injection valve 21a and control device 51 causes first fuel injection valve 21a solely to inject fuel. In this case, as shown in FIG. 12, no matter how the injection pulse width of first fuel injection valve 21a is corrected by the air-fuel ratio feedback control, the fuel injection amount of first fuel injection valve 21a remains unchanged.

Thus, control device 51 cannot cause the air-fuel ratio to approach the target air-fuel ratio. Accordingly, the air-fuel ratio correction variable is added by each round of air-fuel ratio feedback control, and the resultant air-fuel ratio correction value departs from the initial value.

Therefore, when control device 51 determines in step S112 that, as a result of the air-fuel ratio feedback control carried out by causing first fuel injection valve 21a solely to inject fuel, the air-fuel ratio correction value used therein is near the initial value, and thus that the resultant air-fuel ratio error is smaller than the predetermined value, the operation proceeds to step S113. In step S113, control device 51 determines that second fuel injection valve 21b has a measurement abnormality and first fuel injection valve 21a is in a normal condition.

On the other hand, when, based on the air-fuel ratio correction value used in the air-fuel ratio feedback control carried out by causing first fuel injection valve 21a solely to inject fuel, control device 51 determines in step S112 that the resultant air-fuel ratio error is greater than the predetermined value, the operation proceeds to step S115. In step S115, control device 51 determines that first fuel injection valve 21a is stuck open and second fuel injection valve 21b is in a normal condition.

As described above, when the rich-shift abnormality decreases as a result of the first injection control for performing fuel injection while stepwise changing the distribution ratio, control device 51 stops the fuel injection from second fuel injection valve 21b and carries out the second injection control for causing first fuel injection valve 21a solely to inject fuel.

Then, based on the magnitude of the air-fuel ratio error when fuel is injected solely by first fuel injection valve 21a, control device 51 determines whether first fuel injection valve 21a or second fuel injection valve 21b has an abnormality and, in addition, whether the abnormality is a measurement abnormality or valve sticking open.

This prevents or reduces control device 51 from erroneously determining sticking open of first fuel injection valve 21a as a measurement abnormality of second fuel injection valve 21b.

After control device 51 determines whether first fuel injection valve 21a or second fuel injection valve 21b has an abnormality in step S113 or S115, control device 51 performs fail-safe processing, which corresponds to abnormality-addressing processing, based on the determination result.

When control device 51 determines in step S113 that second fuel injection valve 21b has a measurement abnormality and first fuel injection valve 21a is in a normal condition, the operation proceeds to step S114. In step S114, control device 51 stops the fuel injection from second fuel injection valve 21b, which has the measurement abnormality, and causes first fuel injection valve 21a, which is in a normal condition, solely to inject fuel so as to operate internal combustion engine 11.

This allows continuous operation of internal combustion engine 11 with a sufficiently minimized deviation of the base air-fuel ratio.

On the other hand, when control device 51 determines in step S115 that second fuel injection valve 21b is in a normal condition and first fuel injection valve 21a is stuck open, the operation proceeds to step S116. In step S116, control device 51 stops the fuel injection from second fuel injection valve 21b, which is in a normal condition, and causes first fuel injection valve 21a, which is stuck open, solely to inject fuel so as to operate internal combustion engine 11.

In this case, control device 51 cannot stop the fuel injection or adjust the injection amount of first fuel injection valve 21a, and thus, lets first fuel injection valve 21a continuously inject fuel.

However, control device 51 can stop the fuel injection from second fuel injection valve 21b, which is in a normal condition. Thus, control device 51 stops the fuel injection from second fuel injection valve 21b, to reduce the total fuel injection amount as practicably as possible and to prevent or reduce rich-shift abnormality that may occur while internal combustion engine 11 continues to operate in a low load range.

Note that, when control device 51 stops the fuel injection from a fuel injection valve that is in a normal condition and causes a fuel injection valve that is stuck open solely to inject fuel so as to operate internal combustion engine 11 in step S110 or S116, control device 51 may stop carrying out the air-fuel ratio feedback control and stop learning the air-fuel ratio correction value in the air-fuel ratio feedback control.

This is because when a rich-shift abnormality is caused by fuel injected by a fuel injection valve that is stuck open and the fuel injection amounts for one or more other cylinders are corrected downward in order to compensate for the rich-shift abnormality, the air-fuel ratios for all the cylinders deviate from their respective target air-fuel ratios.

Furthermore, when any of the fuel injection valves is stuck open, control device 51 may reduce the fuel supply pressure to the fuel injection valves so as to reduce the amount of fuel injected by the fuel injection valve that is stuck open and thus to prevent or reduce a rich-shift abnormality.

### Second Embodiment

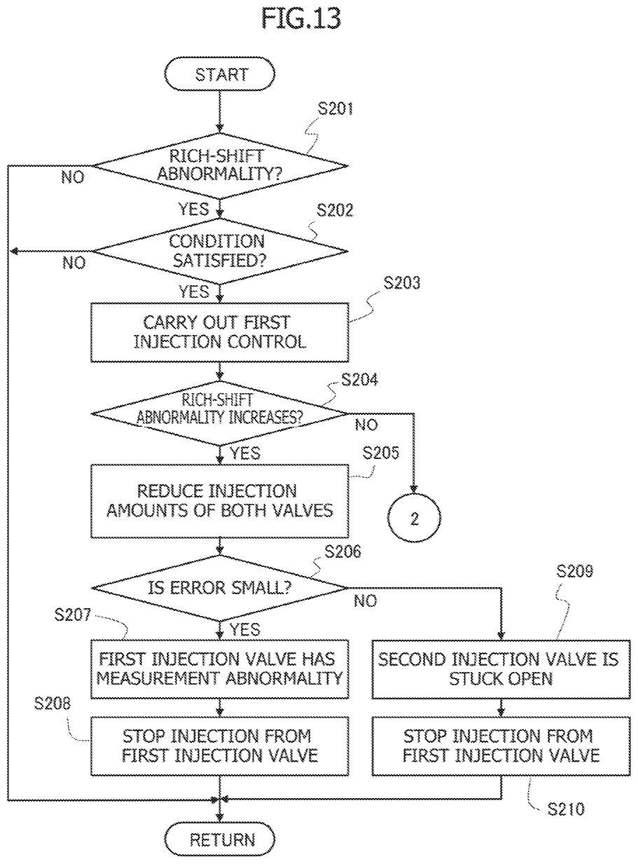

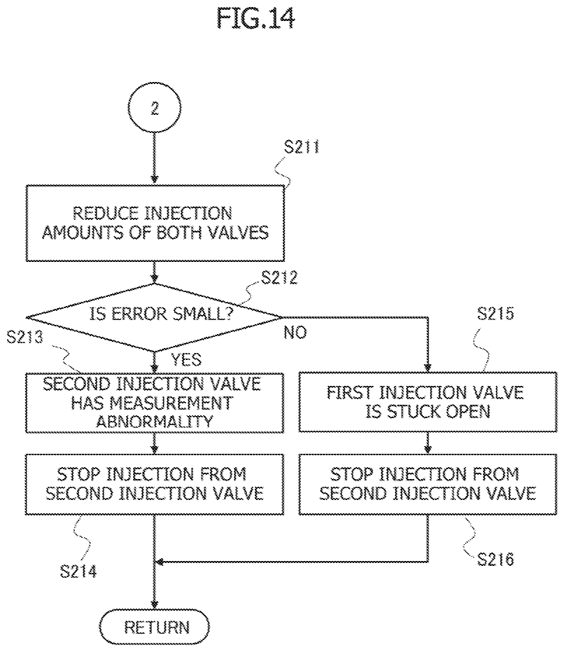

The flowcharts of FIGS. 13 and 14 show a second embodiment of the diagnostic processing performed by control device 51.

In the diagnostic processing according to the flowcharts shown in FIGS. 3 and 4, control device 51 carries out the second injection control for causing a fuel injection valve that may be stuck open solely to inject fuel after carrying out the first injection control for performing fuel injection while stepwise changing the distribution ratio.

In contrast, in the diagnostic processing according to the flowcharts shown in FIGS. 13 and 14, control device 51 carries out an alternative second injection control by causing both first fuel injection valve 21a and second fuel injection valve 21b to inject fuel in a reduced amount so as to reduce the rich-shift abnormality. Then, based on the magnitude of the air-fuel ratio error resulting from the second injection control, control device 51 diagnoses whether a measurement abnormality or valve sticking open causes the rich-shift abnormality.

The operations in steps S201 to S204 of the flowcharts shown in FIGS. 13 and 14 are substantially the same as the operations in step S101 to S104 of FIG. 3. Thus, detailed description therefor will be omitted below.

When control device 51 determines in step S204 that the rich-shift abnormality increases as a result of the first injection control for performing fuel injection while stepwise changing the distribution ratio, the operation proceeds to step S205.

In step S205, control device 51 carries out the second injection control. Specifically, control device 51 carries out the air-fuel ratio feedback control while maintaining the distribution ratio of the fuel injection amount of first fuel injection valve 21a to the fuel injection amount of second fuel injection valve 21b at the predetermined value so as to reduce the fuel injection amount of first fuel injection valve 21a and the fuel injection amount of second fuel injection valve 21b and thus to cause the air-fuel ratio to approach the target air-fuel ratio.

In this event, if second fuel injection valve 21b is stuck open, the higher the distribution ratio of first fuel injection valve 21a is, i.e., the greater the amount of fuel injected by first fuel injection valve 21a is, the further the base air-fuel ratio will shift to the richer side.

Thus, the higher the distribution ratio of first fuel injection valve 21a is, the more easily control device 51 determines whether or not second fuel injection valve 21b is stuck open based on the base air-fuel ratio.

Accordingly, in step S205, control device 51 may set the distribution ratio of first fuel injection valve 21a to a ratio higher than the normal ratio of 50%. For example, control device 51 may maintain the distribution ratio at 8:2, which is specified in the first injection control. Alternatively, however, control device 51 may maintain the distribution ratio at 5:5 in step S205.

When, based on the air-fuel ratio correction value used in the air-fuel ratio feedback control carried out by causing both first fuel injection valve 21a and second fuel injection valve 21b to inject fuel, control device 51 determines in step S206 that the resultant air-fuel ratio error is smaller than the predetermined value, the operation proceeds to step S207. In step S207, control device 51 determines that first fuel injection valve 21a has a measurement abnormality and second fuel injection valve 21b is in a normal condition.

On the other hand, when, based on the air-fuel ratio correction value used in the air-fuel ratio feedback control carried out by causing both first fuel injection valve 21a and second fuel injection valve 21b to inject fuel, control device 51 determines in step S206 that the resultant air-fuel ratio error is greater than the predetermined value, the operation proceeds to step S209. In step S209, control device 51 determines that second fuel injection valve 21b is stuck open and first fuel injection valve 21a is in a normal condition.

When control device 51 determines in step S204 that the rich-shift abnormality decreases as a result of the first injection control for performing fuel injection while stepwise changing the distribution ratio, the operation proceeds to step S211. In this case, the cause of the rich-shift abnormality may be either sticking open of first fuel injection valve 21a or a measurement abnormality of second fuel injection valve 21b.

In step S211, control device 51 carries out the second injection control as in step S205. Specifically, control device 51 carries out the air-fuel ratio feedback control while maintaining the distribution ratio of the fuel injection amount of first fuel injection valve 21a to the fuel injection amount of second fuel injection valve 21b at the predetermined value.

In this event, if first fuel injection valve 21a is stuck open, the higher the distribution ratio of second fuel injection valve 21b is, i.e., the greater the amount of fuel injected by second fuel injection valve 21b is, the further the base air-fuel ratio will shift to the richer side. Thus, the higher the distribution ratio of second fuel injection valve 21b is, the more easily control device 51 determines which type of abnormality has occurred based on the air-fuel ratio error.

Accordingly, in step S211, control device 51 may set the distribution ratio of second fuel injection valve 21b to a ratio higher than the normal ratio of 50%; for example, to 2:8. Alternatively, however, control device 51 may maintain the distribution ratio at 5:5 in step S211.

When, based on the air-fuel ratio correction value used in the air-fuel ratio feedback control carried out by causing both first fuel injection valve 21a and second fuel injection valve 21b to inject fuel, control device 51 determines in step S212 that the resultant air-fuel ratio error is smaller than the predetermined value, the operation proceeds to step S213. In step S213, control device 51 determines that second fuel injection valve 21b has a measurement abnormality and first fuel injection valve 21a is in a normal condition.

On the other hand, when, based on the air-fuel ratio correction value used in the air-fuel ratio feedback control carried out by causing both first fuel injection valve 21a and second fuel injection valve 21b to inject fuel, control device 51 determines in step S212 that the resultant air-fuel ratio error is greater than the predetermined value, the operation proceeds to step S215. In step S215, control device 51 determines that first fuel injection valve 21a is stuck open and second fuel injection valve 21b is in a normal condition.

Here, control device 51 performs fail-safe processing (abnormality-addressing processing) in steps S208, S210, S214, and S216. The details of such fail-safe processing are substantially the same as those in steps S108, S110, S114, and S116 described above. Thus, detailed description therefor will be omitted.

The diagnostic processing according to the flowcharts shown in FIGS. 13 and 14 also allows control device 51 to determine whether first fuel injection valve 21a or second fuel injection valve 21b has an abnormality and whether the abnormality is a measurement abnormality or valve sticking open. Thus, control device 51 can perform fail-safe processing appropriately in accordance with which type of abnormality has occurred.

The first and second embodiments described above may be applicable to a variable fuel pressure control system configured to variably control the pressure or rate (discharge rate of the fuel pump) of fuel supplied to the fuel injection valves in accordance with engine operating conditions. Furthermore, the first and second embodiments described above may also be applicable to a system using a pressure regulating valve or the like to maintain the fuel pressure or the fuel supply rate (discharge rate of the fuel pump) at a fixed value.

### Third Embodiment

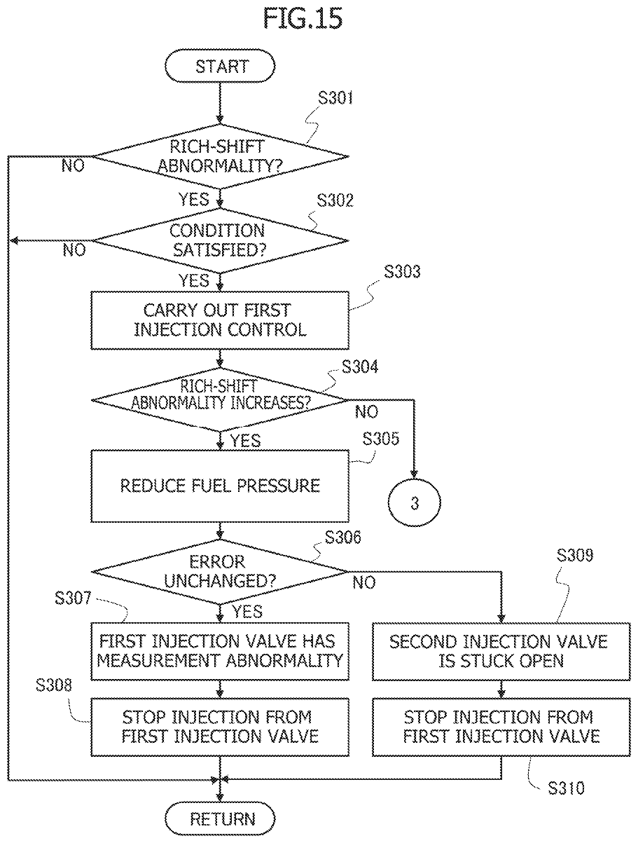

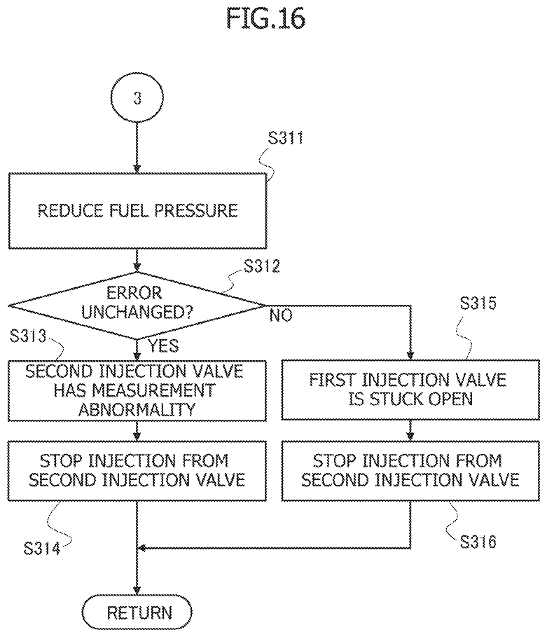

The flowcharts of FIGS. 15 and 16 show a third embodiment of the diagnostic processing performed by control device 51.

In the diagnostic processing according to the flowcharts shown in FIGS. 15 and 16, control device 51 carries out a still alternative second injection control. Specifically, as the second injection control, control device 51 causes both first fuel injection valve 21a and second fuel injection valve 21b to inject fuel while maintaining the injection distribution ratio at a predetermined ratio and supplying fuel to first fuel injection valve 21a and second fuel injection valve 21b at a reduced pressure.

The operations in steps S301 to S304 of the flowcharts shown in FIGS. 15 and 16 are substantially the same as the operations in step S101 to S104 of FIG. 3. Thus, detailed description therefor will be omitted below.

When control device 51 determines in step S304 that the rich-shift abnormality increases as a result of the first injection control for performing fuel injection while stepwise changing the distribution ratio, the operation proceeds to step S305. In this case, the cause of the rich-shift abnormality may be either sticking open of first fuel injection valve 21a or a measurement abnormality of second fuel injection valve 21b.

In step S305, control device 51 carries out the second injection control. Specifically, control device 51 reduces the pressure of fuel supplied to first fuel injection valve 21a and second fuel injection valve 21b while maintaining the fuel injection distribution ratio of first fuel injection valve 21a to second fuel injection valve 21b at the predetermined value, and corrects the injection pulse width of first fuel injection valve 21a and the injection pulse width of second fuel injection valve 21b upward in accordance with the decrease of injection per unit time along with the reduction of the fuel pressure.

In this event, if second fuel injection valve 21b is stuck open, the higher the distribution ratio of first fuel injection valve 21a is, i.e., the greater the amount of fuel injected by first fuel injection valve 21a is, the further the base air-fuel ratio will shift to the richer side.

Thus, the higher the distribution ratio of first fuel injection valve 21a is, the more easily control device 51 determines whether or not second fuel injection valve 21b is stuck open based on the base air-fuel ratio (air-fuel ratio error).

Accordingly, in step S305, control device 51 may set the distribution ratio of first fuel injection valve 21a to a ratio higher than the normal ratio of 50%. For example, control device 51 may maintain the distribution ratio at 8:2, which is specified in the first injection control. Alternatively, however, control device 51 may maintain the distribution ratio at 5:5 in step S305.

Then, in step S306, control device 51 determines whether the correction value used in the air-fuel ratio feedback control in the second injection control decreases or remains unchanged as a result of the second injection control.

If second fuel injection valve 21b is stuck open, changing the injection pulse width of second fuel injection valve 21b will not change the injection amount of second fuel injection valve 21b but decreasing the fuel pressure will reduce the injection amount of second fuel injection valve 21b.

At that time, if first fuel injection valve 21a is in a normal condition, first fuel injection valve 21a will inject a substantially constant amount of fuel no matter how fuel pressure changes. Thus, in this case, decreasing the fuel pressure will reduce the total injection amount from first fuel injection valve 21a and second fuel injection valve 21b and thus, will reduce the air-fuel ratio error.

On the other hand, if first fuel injection valve 21a has a measurement abnormality, no matter how fuel pressure changes, control device 51 will correct the injection pulse width of first fuel injection valve 21a in accordance with the decrease of the fuel pressure so that first fuel injection valve 21a will inject fuel in a substantially constant, erroneous amount dictated by its injection characteristics.

At that time, if second fuel injection valve 21b is in a normal condition, second fuel injection valve 21b will inject a substantially constant amount of fuel no matter how fuel pressure changes. Thus, in this case, the total injection amount from first fuel injection valve 21a and second fuel injection valve 21b will remain substantially unchanged and thus, the air-fuel ratio error will remain substantially unchanged.

Therefore, when control device 51 determines that the correction value used in the air-fuel ratio feedback control in the second injection control, i.e., the air-fuel ratio error, remains substantially unchanged as a result of the second injection control, the operation proceeds to step S307. In step S307, control device 51 determines that first fuel injection valve 21a has a measurement abnormality and second fuel injection valve 21b is in a normal condition.

On the other hand, when control device 51 determines in step S306 that the correction value used in the air-fuel ratio feedback control decreases as a result of the second injection control, the operation proceeds to step S309. In step S309, control device 51 determines that second fuel injection valve 21b is stuck open and first fuel injection valve 21a is in a normal condition.

When control device 51 determines in step S304 that the rich-shift abnormality decreases as a result of the first injection control for performing fuel injection while stepwise changing the distribution ratio, the operation proceeds to step S311.

In this case, the cause of the rich-shift abnormality may be either a measurement abnormality of second fuel injection valve 21b or sticking open of first fuel injection valve 21a.

In step S311, control device 51 carries out the second injection control as in step S305. Specifically, control device 51 reduces the pressure of fuel supplied to first fuel injection valve 21a and second fuel injection valve 21b while maintaining the fuel injection distribution ratio of first fuel injection valve 21a to second fuel injection valve 21b at the predetermined value, and corrects the injection pulse width of first fuel injection valve 21a and the injection pulse width of second fuel injection valve 21b in accordance with the change of injection per unit time along with the change of the fuel pressure.

In this event, if first fuel injection valve 21a is stuck open, the higher the distribution ratio of second fuel injection valve 21b is, i.e., the greater the amount of fuel injected by second fuel injection valve 21b is, the further the base air-fuel ratio will shift to the richer side.

Thus, the higher the distribution ratio of second fuel injection valve 21b is, the more easily control device 51 determines whether or not first fuel injection valve 21a is stuck open based on the base air-fuel ratio.

Accordingly, in step S311, control device 51 may set the distribution ratio of second fuel injection valve 21b to a ratio higher than the normal ratio of 50%. For example, control device 51 may maintain the distribution ratio of first fuel injection valve 21a to second fuel injection valve 21b at 2:8. Alternatively, however, control device 51 may maintain the distribution ratio at 5:5 in step S311.

Then, in step S311, control device 51 determines whether the correction value used in the air-fuel ratio feedback control in the second injection control decreases or remains unchanged as a result of the second injection control.

If first fuel injection valve 21a is stuck open, changing the injection pulse width of first fuel injection valve 21a will not change the injection amount of first fuel injection valve 21a but decreasing the fuel pressure will reduce the injection amount of first fuel injection valve 21a.

At that time, if second fuel injection valve 21b is in a normal condition, second fuel injection valve 21b will inject a substantially constant amount of fuel no matter how fuel pressure changes. Thus, in this case, decreasing the fuel pressure will reduce the total injection amount from first fuel injection valve 21a and second fuel injection valve 21b and thus, will reduce the air-fuel ratio error.

On the other hand, if second fuel injection valve 21b has a measurement abnormality, no matter how fuel pressure changes, control device 51 will correct the injection pulse width of second fuel injection valve 21b in accordance with the decrease of the fuel pressure so that second fuel injection valve 21b will inject fuel in a substantially constant, erroneous amount dictated by its injection characteristics.

At that time, if first fuel injection valve 21a is in a normal condition, first fuel injection valve 21a will inject a substantially constant amount of fuel no matter how fuel pressure changes. Thus, in this case, the total injection amount from first fuel injection valve 21a and second fuel injection valve 21b will remain substantially unchanged and thus, the air-fuel ratio error will remain substantially unchanged.

Therefore, when control device 51 determines that the correction value used in the air-fuel ratio feedback control in the second injection control remains substantially unchanged as a result of the second injection control, the operation proceeds to step S313. In step S313, control device 51 determines that second fuel injection valve 21b has a measurement abnormality and first fuel injection valve 21a is in a normal condition.

On the other hand, when control device 51 determines in step S312 that the correction value used in the air-fuel ratio feedback control decreases as a result of the second injection control, the operation proceeds to step S315. In step S315, control device 51 determines that first fuel injection valve 21a is stuck open and second fuel injection valve 21b is in a normal condition.

Here, control device 51 performs fail-safe processing, which corresponds to abnormality-addressing processing, in steps S308, S310, S314, and S316. The details of such fail-safe processing are substantially the same as those in steps S108, S110, S114, and S116 described above. Thus, detailed description therefor will be omitted.

The diagnostic processing according to the flowcharts shown in FIGS. 15 and 16 also allows control device 51 to determine whether first fuel injection valve 21a or second fuel injection valve 21b has an abnormality and whether the abnormality is a measurement abnormality or valve sticking open. Thus, control device 51 can perform fail-safe processing appropriately in accordance with which type of abnormality has occurred.

Hereinabove, the embodiments have been described above. However, the present invention is not limited to these but encompasses various modifications. The above embodiments include details that are only intended to clearly illustrate the present invention. Thus, the present invention is not necessarily limited to one having all the features described herein, for example.

Furthermore, one or more features of an embodiment herein may be replaced with corresponding features of another embodiment. Also, an embodiment herein may further include one or more features of another embodiment, and one or more features of an embodiment herein may be omitted.

For example, when either first fuel injection valve 21a or second fuel injection valve 21b is stuck open, control device 51 may take measures to remove foreign matter from the fuel injection valve that is abnormally stuck open, such as repeatedly opening and closing the fuel injection valve and/or increasing the fuel pressure.

Alternatively or additionally, when either first fuel injection valve 21a or second fuel injection valve 21b is stuck open, control device 51 may stop the fuel supply to the fuel injection valve that is abnormally stuck open and maintain fuel injection from the remaining fuel injection valve that is in a normal condition.

Furthermore, when a measurement abnormality has occurred in either first fuel injection valve 21a or second fuel injection valve 21b, control device 51 may decrease the distribution ratio of the fuel injection valve that has the measurement abnormality to a ratio that is more than 0% but less than the value to be, which is employed under normal conditions, and cause both fuel injection valves 21a, 21b to inject fuel in amounts at the distribution ratio.

Furthermore, when either first fuel injection valve 21a or second fuel injection valve 21b is stuck open and control device 51 stops the fuel injection from the fuel injection valve that is in a normal condition, control device 51 may adjust the fuel pressure in accordance with the load of internal combustion engine 11 or the like, so as to increase (decrease) the amount of fuel injected by the fuel injection valve that is abnormally stuck open, in accordance with the increase (decrease) of the engine load.

Also, when both first fuel injection valve 21a and second fuel injection valve 21b are in a normal condition, control device 51 may cause first fuel injection valve 21a and second fuel injection valve 21b to inject fuel at the same injection timing or at mutually different injection timings.

Furthermore, when a fuel injection valve of any of the cylinders includes a measurement abnormality, control device 51 may stop fuel injection to the cylinder having the fuel injection valve in an abnormal condition so as to deactivate the cylinder.

### REFERENCE SYMBOL LIST

11 Internal combustion engine
15a, 15b Intake port
21a, 21b Fuel injection valve
34 Air-fuel ratio sensor
Control device

1. A control device for an internal combustion engine provided with a first fuel injection valve and a second fuel injection valve for a cylinder, the control device comprising:
a diagnosing unit configured such that, when there is an abnormality that makes an air-fuel ratio of the internal combustion engine richer than a specified value, the diagnosing unit determines whether the first fuel injection valve or the second fuel injection valve has the abnormality, based on
change of the air-fuel ratio occurring as a result of first injection control for performing fuel injection while changing a distribution ratio of a fuel injection amount distributed to the first fuel injection valve to a fuel injection amount distributed to the second fuel injection valve, and
a value of the air-fuel ratio obtained as a result of second injection control for performing fuel injection while maintaining the distribution ratio at a predetermined ratio.

2. The control device for the internal combustion engine according to claim 1,
wherein the second injection control is carried out by causing either the first fuel injection valve or the second fuel injection valve to inject fuel, and
wherein, based on the change of the air-fuel ratio occurring as a result of the first injection control, the diagnosing unit selects whether the first fuel injection valve or the second fuel injection valve is to inject fuel in the second injection control.

3. The control device for the internal combustion engine according to claim 2,
wherein the first injection control is carried out while increasing the distribution ratio of the fuel injection amount distributed to the first fuel injection valve to the fuel injection amount distributed to the second fuel injection valve, and
wherein
when the air-fuel ratio becomes still richer as a result of the first injection control, the diagnosing unit causes the second fuel injection valve to inject fuel in the second injection control, and
when the air-fuel ratio approaches the specified value as a result of the first injection control, the diagnosing unit causes the first fuel injection valve to inject fuel in the second injection control.

4. The control device for the internal combustion engine according to claim 3,
wherein as a result of the second injection control carried out by causing the second fuel injection valve to inject fuel,
when the air-fuel ratio does not deviate from the specified value or deviates from the specified value by an amount less than a first threshold, the diagnosing unit determines that the first fuel injection valve has the abnormality, and
when the air-fuel ratio deviates from the specified value by an amount more than the first threshold, the diagnosing unit determines that the second fuel injection valve has the abnormality, and
wherein as a result of the second injection control carried out by causing the first fuel injection valve to inject fuel,
when the air-fuel ratio does not deviate from the specified value or deviates from the specified value by an amount less than the first threshold, the diagnosing unit determines that the second fuel injection valve has the abnormality, and
when the air-fuel ratio deviates from the specified value by an amount more than the first threshold, the diagnosing unit determines that the first fuel injection valve has the abnormality.

5. The control device for the internal combustion engine according to claim 3,
wherein as a result of the second injection control carried out by causing the second fuel injection valve to inject fuel,
when the air-fuel ratio does not deviate from the specified value or deviates from the specified value by an amount less than a first threshold, the diagnosing unit determines that the first fuel injection valve has a measurement abnormality, and
when the air-fuel ratio deviates from the specified value by an amount more than the first threshold, the diagnosing unit determines that the second fuel injection valve is stuck open, and
wherein as a result of the second injection control carried out by causing the first fuel injection valve to inject fuel,
when the air-fuel ratio does not deviate from the specified value or deviates from the specified value by an amount less than the first threshold, the diagnosing unit determines that the second fuel injection valve has a measurement abnormality, and
when the air-fuel ratio deviates from the specified value by an amount more than the first threshold, the diagnosing unit determines that the first fuel injection valve is stuck open.

6. The control device for the internal combustion engine according to claim 1,
wherein the first injection control is carried out while increasing the distribution ratio of the fuel injection amount distributed to the first fuel injection valve to the fuel injection amount distributed to the second fuel injection valve,
wherein the second injection control is carried out by causing both the first fuel injection valve and the second fuel injection valve to inject a reduced amount of fuel while maintaining the distribution ratio at a predetermined ratio,
wherein when the air-fuel ratio becomes still richer as a result of the first injection control,
when the air-fuel ratio deviates from the specified value by an amount more than a second threshold as a result of the second injection control, the diagnosing unit determines that the second fuel injection valve is stuck open, and
when the air-fuel ratio does not deviate from the specified value or deviates from the specified value by an amount less than the second threshold as a result of the second injection control, the diagnosing unit determines that the first fuel injection valve has a measurement abnormality, and
wherein when the air-fuel ratio approaches the specified value as a result of the first injection control,
when the air-fuel ratio deviates from the specified value by an amount more than a second threshold as a result of the second injection control, the diagnosing unit determines that the first fuel injection valve is stuck open, and
when the air-fuel ratio does not deviate from the specified value or deviates from the specified value by an amount less than the second threshold as a result of the second injection control, the diagnosing unit determines that the second fuel injection valve has a measurement abnormality.

7. The control device for the internal combustion engine according to claim 1,
wherein the first injection control is carried out while increasing the distribution ratio of the fuel injection amount distributed to the first fuel injection valve to the fuel injection amount distributed to the second fuel injection valve,
wherein the second injection control is carried out by causing both the first fuel injection valve and the second fuel injection valve to inject fuel while
maintaining the distribution ratio at a predetermined ratio,
supplying fuel to the first fuel injection valve and the second fuel injection valve at a reduced pressure, and
correcting an injection pulse width of the first fuel injection valve and an injection pulse width of the second fuel injection valve upward in accordance with reduction of the pressure of the fuel,
wherein when the air-fuel ratio becomes still richer as a result of the first injection control,
when the air-fuel ratio approaches the specified value as a result of the second injection control, the diagnosing unit determines that the second fuel injection valve is stuck open, and
when the air-fuel ratio does not approach the specified value as a result of the second injection control, the diagnosing unit determines that the first fuel injection valve has a measurement abnormality, and
wherein when approaches the specified value as a result of the first injection control,
when the air-fuel ratio approaches the specified value as a result of the second injection control, the diagnosing unit determines that the first fuel injection valve is stuck open, and
when the air-fuel ratio does not approach the specified value as a result of the second injection control, the diagnosing unit determines that the second fuel injection valve has a measurement abnormality.

8. The control device for the internal combustion engine according to claim 5, the control device further comprising
an abnormality-addressing processing unit configured to perform abnormality-addressing processing in accordance with a diagnosis provided by the diagnosing unit,
wherein when the diagnosing unit determines that the first fuel injection valve has a measurement abnormality, the abnormality-addressing processing unit stops fuel injection from the first fuel injection valve and maintains fuel injection from the second fuel injection valve so as to operate the internal combustion engine,
wherein when the diagnosing unit determines that the second fuel injection valve is stuck open, the abnormality-addressing processing unit stops fuel injection from the first fuel injection valve and maintains fuel injection from the second fuel injection valve so as to operate the internal combustion engine,
wherein when the diagnosing unit determines that the second fuel injection valve has a measurement abnormality, the abnormality-addressing processing unit stops fuel injection from the second fuel injection valve and maintains fuel injection from the first fuel injection valve so as to operate the internal combustion engine, and
wherein when the diagnosing unit determines that the first fuel injection valve is stuck open, the abnormality-addressing processing unit stops fuel injection from the second fuel injection valve and maintains fuel injection from the first fuel injection valve so as to operate the internal combustion engine.

9. A diagnostic method for an internal combustion engine provided with a first fuel injection valve and a second fuel injection valve for a cylinder, the diagnostic method comprising:
carrying out first injection control for performing fuel injection while changing a distribution ratio of a fuel injection amount distributed to the first fuel injection valve to a fuel injection amount distributed to the second fuel injection valve, when there is an abnormality that makes an air-fuel ratio of the internal combustion engine richer than a specified value;
determining change of the air-fuel ratio occurring as a result of the first injection control;
carrying out second injection control for performing fuel injection while maintaining the distribution ratio at a predetermined ratio;
determining a deviation, from the specified value, of the air-fuel ratio obtained as a result of the second injection control; and
determining whether the first fuel injection valve or the second fuel injection valve has the abnormality, based on the change of the air-fuel ratio occurring as a result of the first injection control and the deviation of the air-fuel ratio obtained as a result of the second injection control.

10. The diagnostic method for the internal combustion engine according to claim 9,
wherein the second injection control is carried out by causing either the first fuel injection valve or the second fuel injection valve to inject fuel, and
wherein, based on the change of the air-fuel ratio occurring as a result of the first injection control, it is selected whether the first fuel injection valve or the second fuel injection valve is to inject fuel in the second injection control.

11. The diagnostic method for the internal combustion engine according to claim 10,
wherein the first injection control is carried out while increasing the distribution ratio of the fuel injection amount distributed to the first fuel injection valve to the fuel injection amount distributed to the second fuel injection valve, and
wherein
when the air-fuel ratio becomes still richer as a result of the first injection control, the second fuel injection valve injects fuel in the second injection control, and
when the air-fuel ratio approaches the specified value as a result of the first injection control, the first fuel injection valve injects fuel in the second injection control.

12. The diagnostic method for the internal combustion engine according to claim 11,
wherein as a result of the second injection control carried out by causing the second fuel injection valve to inject fuel,
when the air-fuel ratio does not deviate from the specified value or deviates from the specified value by an amount less than a first threshold, it is determined that the first fuel injection valve has the abnormality, and
when the air-fuel ratio deviates from the specified value by an amount more than the first threshold, it is determined that the second fuel injection valve has the abnormality, and
wherein as a result of the second injection control carried out by causing the first fuel injection valve to inject fuel,
when the air-fuel ratio does not deviate from the specified value or deviates from the specified value by an amount less than the first threshold, it is determined that the second fuel injection valve has the abnormality, and
when the air-fuel ratio deviates from the specified value by an amount more than the first threshold, it is determined that the first fuel injection valve has the abnormality.
